(19) United States
(12) Patent Application Publication
(10) Pub. No.: US 2011/0012279 A1
(43) Pub. Date: Jan. 20, 2011

(54) METHOD AND APPARATUS FOR IMPROVED DETECTION OF HOLES IN PLASTIC CONTAINERS

(76) Inventors: David A. Bogstad, Perrysburg, OH (US); Aaron Raphael Teitlebaum, Holland, OH (US); Adam E. Brunella, Temperance, MI (US)

Correspondence Address: FRASER CLEMENS MARTIN & MILLER LLC, 28366 KENSINGTON LANE, PERRYSBURG, OH, 43551, US

(21) Appl. No.: 12/933,103

(22) PCT Filed: Mar. 17, 2009
(86) PCT No.: PCT/US09/37376

§ 371 Date: Sep. 17, 2010

Related U.S. Application Data
(60) Provisional application No. 61/037,156, filed on Mar. 17, 2008.

(51) Int. Cl. B29C 49/80

(52) U.S. Cl. 264/40.1; 425/135

(57) ABSTRACT

A method and apparatus for monitoring the production of blow molded plastic containers is disclosed, wherein the method and apparatus utilize a sound detector assembly adapted to be positioned adjacent a mold cavity during the introduction of pressure fluid to a preform in the mold cavity to form a container, the sound detector assembly including a reflector having a substantially conic cross-sectional shape and a sound detector and being responsive to a defect sound of the pressure fluid escaping from the interior of the container for generating an output signal.

### CROSS-REFERENCE TO RELATED APPLICATION

This application claims the benefit of U.S. Provisional Patent Application Ser. No. 61/037,156 filed on Mar. 17, 2008.

### FIELD OF THE INVENTION

The invention relates to a method and apparatus for monitoring the production of plastic blow molded containers. More particularly, the invention contemplates the sensing of two general classes of defects found in Reheat Stretch Blow Molded PET containers. The first class of defects relates to the formation of holes in the feet and/or walls of the plastic blow molded containers during the blow molding process. The second class of defects relates to a pre-existing condition in the injection molded preform particularly in the finish area generated either in the injection process or during handling and loading of the preform prior to the blow molding operation. These defects are identified by monitoring the sound emitting from a pressure fluid introduced into the containers and caused to pass through the defects adjacent a predetermined location along the production line of plastic blow molded containers.

### BACKGROUND OF THE INVENTION

The leak testing of tanks, pressure vessels, and containers is an important manufacturing consideration in many different industries. There are certain instances in which, the completed container may have undetected faults such as, for example, minute holes or apertures in the walls of plastic containers. When the faulty containers are subsequently filled with a fluid such as a carbonated beverage, undesirable results occur. Accordingly, it has become extremely important to develop a method and apparatus for the timely detection of these difficult to detect faults in plastic containers.

In some instances, the gas-tight or liquid-tight integrity of the container is determined by a pressure-decay test. With the pressure-decay test, the container under test is injected with air to a desired overpressure, and the pressure is monitored for a specified period of time. If the pressure does not decay below a specified value at the end of the designated time period, the component under test is considered to be leak-free.

Another technique involves drawing a vacuum in the container being tested and then completely surrounding it with helium gas. A detector inside the vacuum system indicates if helium is present in the air being pumped from the container under test.

Another method involves the pressurization/immersion technique which consists of pressurizing the container, completely immersing the container in water or some other clear liquid, and observing the point of bubble emergence.

Yet another method utilizes a collimated beam of light which is scanned across the container under test. The test container is typically pressurized with a tracer gas that absorbs a portion of the light. When the light passes through the gas emerging from the source of the leak, the light energy absorbed by the gas produces an acoustic emission which is detected by a microphone. The resulting signal may be processed either as an alarm or it may be processed in coordination with the beam scanning mechanism to indicate the location of the leak.

Another method involves an apparatus adapted to detect the sound issued outwardly by the individual blow-molding dies during the blow-molding process wherein the sound is converted to an electrical signal and is compared with a reference signal or level and the faulty container is rejected. However, because the detection means of the methods and apparatus adapted to detect a sound may detect background noise, acceptable containers may be incorrectly rejected.

Despite the container inspection apparatuses known in the art, there is a continuing need for an improved method and apparatus for monitoring the production of blow molded plastic containers to detect the presence of a hole defect or a finish defect in the container during production of the containers and producing a signal in response thereto.

### SUMMARY OF THE INVENTION

Concordant and congruous with the present invention, an improved method and apparatus for monitoring the production of blow molded plastic containers to detect the presence of a hole defect or a finish defect in the container during production of the containers and producing a signal in response thereto has surprisingly been discovered.

In one embodiment, a method for monitoring the production of blow molded plastic containers to detect a defect in any of the containers comprises the steps of:
a. introducing pressure fluid to an interior of a preform in a mold cavity to form a blow molded plastic container;
b. providing a sound detector assembly including a reflector having a substantially conic section cross-sectional shape and a sound detector;
c. acoustically sensing a defect sound with the sound detector assembly resulting from the pressure fluid escaping from the interior of the container; and
d. generating a control signal in response to the sensed defect sound.

In another embodiment, an apparatus for monitoring the production of blow molded plastic containers formed by introducing pressure fluid to an interior of a preform in a mold cavity comprises a sound detector assembly adapted to be positioned adjacent a mold cavity during the introduction of pressure fluid to a preform in the mold cavity to form a container, said sound detector assembly including a sound detector and a reflector having a substantially conic section cross-sectional shape and being responsive to a defect sound of the pressure fluid escaping from the interior of the container for generating an output signal; and means for generating a control signal in response to said output signal whereby a container rejecter receiving said control signal rejects the container.

In another embodiment, an apparatus for monitoring the production of blow molded plastic containers formed by introducing pressure fluid to an interior of a preform in a mold cavity comprises a sound detector assembly adapted to be positioned adjacent a mold cavity during the introduction of pressure fluid to a preform in the mold cavity to form a container, said sound detector assembly including a sound detector responsive to a defect sound of the pressure fluid escaping from the interior of the container for generating an output signal and a reflector having a substantially conic section cross-sectional shape and a support extending between walls thereof, the support forming an aperture adapted to receive the sound detector; and means for generating a control signal in response to said output signal whereby a container rejecter receiving said control signal rejects the container.

### BRIEF DESCRIPTION OF THE DRAWINGS

Other objects and advantages of the invention will become readily apparent to those skilled in the art from reading the following detailed description of a preferred embodiment of the invention when considered in the light of the accompanying drawings in which:

FIG. 1 is a schematic diagram of a detection system including an acoustic reflector according to an embodiment of the invention;

FIG. 2 is a plan view of the acoustic reflector of FIG. 1;

FIG. 3 is a cross-sectional view of the reflector of FIG. 2 taken along line 3-3 thereof;

FIG. 4 is a cross-sectional view of the acoustic reflector of FIG. 2 taken along line 4-4 thereof;

FIG. 5 is a schematic sectional view of the acoustic reflector of FIGS. 1-4 illustrating the reflection of sound energy therefrom;

FIG. 6 is a plan view of an acoustic reflector according to another embodiment of the invention;

FIG. 7 sectional view of an acoustic reflector of FIG. 6 taken along line 7-7 thereof; and

FIG. 8 is a side view of an acoustic reflector according to another embodiment of the invention.

### DETAILED DESCRIPTION OF EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

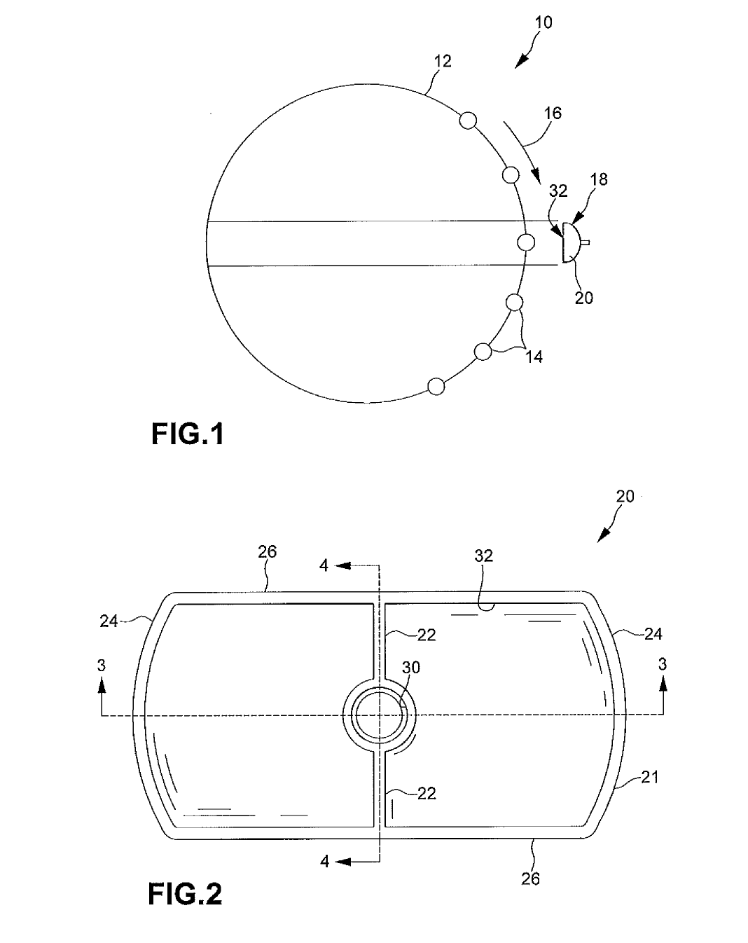

FIG. 1 is a diagrammatic illustration of a blow molding apparatus 10 according to an embodiment of the invention. The blow molding apparatus 10 includes an annular rotatably mounted platform 12 having a plurality of molds 14 capable of serially receiving hollow plastic preforms or parisons therein, and an associated sound detector assembly 18. The blow molding apparatus 10 and platform 12 are similar to apparatus manufactured by Sidel, a corporation of France.

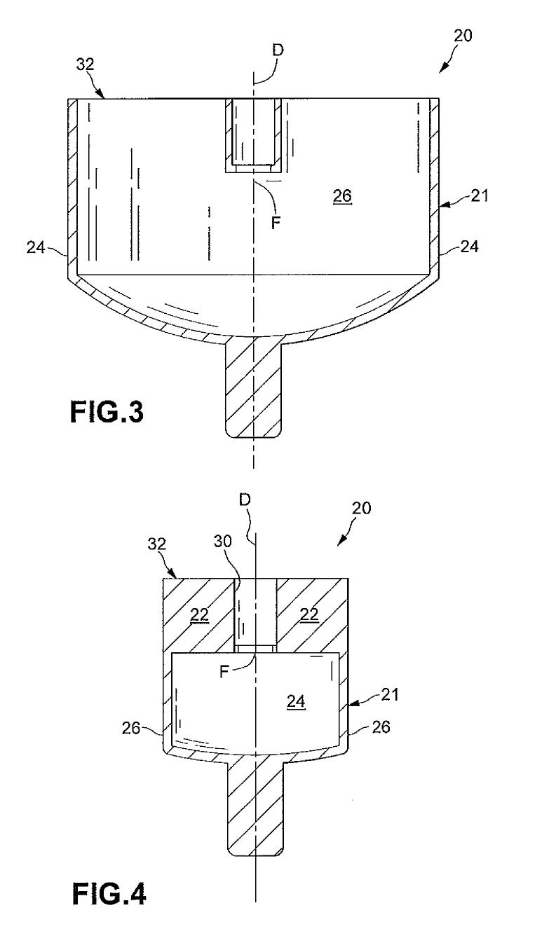

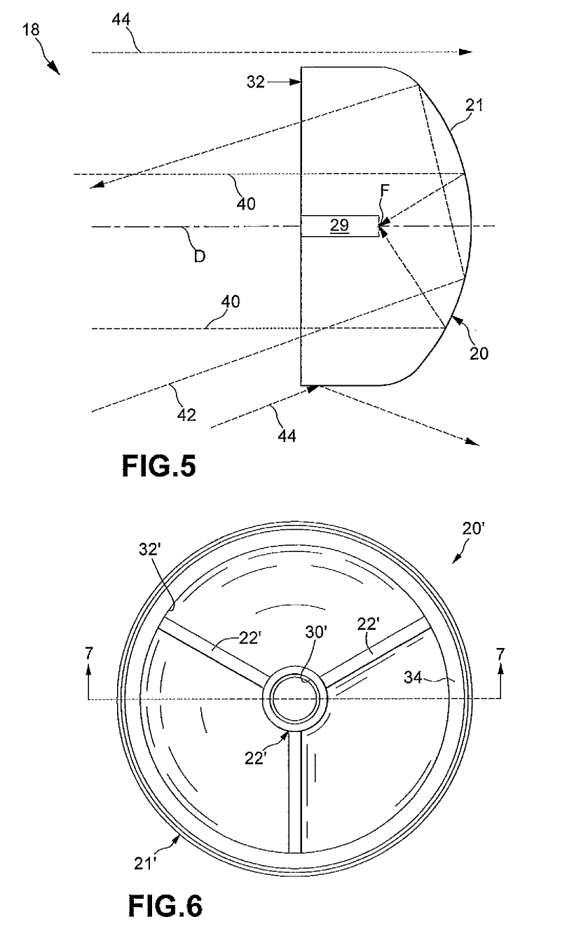

The sound detector assembly 18 includes a substantially hollow acoustic reflector 20, as shown in FIGS. 1-5, and a sound detector 29, as shown in FIG. 5. The acoustic reflector 20 includes a housing 21 formed by a pair of curvilinear end walls 24 joined together by a pair of spaced apart rectilinear walls 26 and having a substantially rectangular opening 32. The housing 21 of the reflector 20 has a substantially parabolic cross-sectional shape. It is understood that the housing 21 may have any conic cross-sectional shape such as elliptical, hyperbolic, and circular, for example, as desired. The housing 21 of the reflector 20 may be formed from a polymeric material, such as PET or PVC, or the housing 21 may be formed from a foamed material, as desired. In the embodiment shown, a support 22 is provided to extend between the walls 26. The support 22 is disposed within the housing 21 of the reflector 20 and does not extend out of the opening 32 of the housing 21. The sound detector 29 is frictionally fit within an aperture 30 disposed centrally of the support 22. However, an internally threaded aperture 30 may be disposed centrally of the support 22 to receive the sound detector 29, as desired. It is understood that the support 22 may be formed integral with the housing 21, or the support 22 may be separately formed and fixed to the housing 21, as desired. The aperture 30 is formed in the support 22 at a focus F, and along the directrix D of the parabola formed by the housing 21. The sound detector 29 has an input facing the hollow interior of the housing 21. The sound detector 29 suitable for the purposes of the invention is commercially available from and identified as a UE Systems ultrasonic sensor and preamplifier Model 586, though any conventional sound detector may be used.

In use, as illustrated schematically in FIG. 1, preforms are carried in the molds 14 of the blow molding apparatus 10. The molds 14 have an inner cavity in the desired configuration or shape of a finished container to be formed. The preforms are heated to a predetermined temperature, which prepares the plastic material to be readily blow molded. Upon reaching the desired temperature, high pressure fluid, such as compressed air, is sequentially introduced into the hollow interiors of the preforms. The preforms are thereby caused to expand and assume the shape of the inner cavity of the mold 14 as a completed container.

As the pressure fluid is introduced into the molds 14 to form the container, the platform 12 and the molds 14 of the blow molding apparatus 10 are caused to rotate in a direction indicated by arrow 16 and pass the sound detector assembly 18 disposed adjacent the periphery of the rotating platform 12. The sound detector assembly 18 is disposed with the opening 32 thereof facing the platform 12. In the event a hole is formed in the wall of the container, the pressure fluid enters an open upper end or finish of the container and escapes through the hole creating an acoustic signal or defect sound energy. Sound energy is directed toward the opening 32 of the reflector 20. Because the sound detector 29 is disposed at the focus F of the parabola formed by the housing 21, sound energy 40 caused to travel parallel to the directrix D is reflected off the interior of the housing 21 of the reflector 20 towards the focus F and the sound detector 29, as illustrated in FIG. 5. Sound energy 42 not parallel to the directrix D tends to be reflected from the interior surface of the reflector 20 and is directed out of the sound detector assembly 18 and is undetected by the sound detector 29. This has been found to reduce the detection of background noise from adjacent molds 14 and sources other than a desired source, namely, the air caused to flow through defects in the container. Sound energy 44 not entering the opening 32 of the reflector 20 is reflected from an exterior of the housing 21 and projected past the housing 21 and is not detected by the sound detector 29. This has also been found to reduce the effects of background noise from undesired sources.

The sound detector 29 generates an electric signal in response to detection of sound energy. The electric signal may then be sent to an amplifier (not shown) and then to a logic circuit (not shown). The logic circuit is operative to coordinate and keep track of the subsequent path of the container having the defect and will send an appropriately timed control signal to an air blow-off station to remove the container from the production line prior to filling or storage. The station may contain solenoid-operated valves controlling the flow of pressurized air capable of completing the rejection operation. The pressurized air will then be appropriate to remove the container with the defect from the production line. The completed plastic containers are then transferred from the annular rotating platform 12 to a conveyor which transports the containers to a filling station. Finally, the filled containers are removed from the conveyor to be stored for later delivery or are immediately loaded on appropriate vehicles for delivery to an end-user of the container. Unfilled containers may also be off-loaded in a similar fashion.

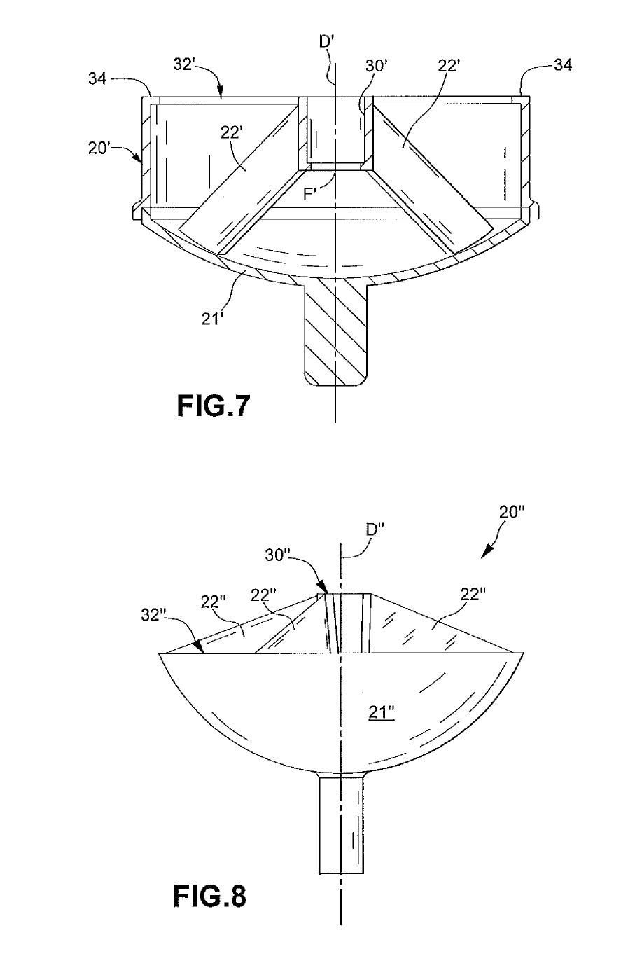

FIGS. 6 and 7 show a reflector 20′ according to another embodiment of the invention similar to the reflector 20 of FIGS. 1-5 except as described below. Like the structure from FIGS. 1-5, FIGS. 6 and 7 include identical reference numerals accompanied by a prime (′) symbol.

A sound detector assembly includes a substantially hollow acoustic reflector 20′ and a sound detector (not shown). As shown in FIGS. 6 and 7, the acoustic reflector 20′ includes a housing 21′ having a substantially circular opening 32′. The housing 21′ of the reflector 20′ has a substantially parabolic cross-sectional shape. It is understood that the housing 21′ may have any conic cross-sectional shape such as elliptical, hyperbolic, and circular, for example, as desired. The housing 21′ of the reflector 20′ may be formed from a polymeric material, such as PET or PVC, or the housing 21′may be formed from a foamed material, as desired. In the embodiment shown, a support 22′ is provided to extend between the walls forming the housing 21′. A sound detector (not shown) is frictionally fit within an aperture 30′ disposed centrally of the support 22′. However, an internally threaded aperture 30′ may be disposed centrally of the support 22′ to receive the sound detector, as desired. The aperture 30′ is formed in the support 22′ at a focus F′ and along the directrix D′ of the parabola formed by the housing 21′. The sound detector has an input facing the hollow interior of the reflector 20′. The sound detector suitable for the purposes of the invention is commercially available from and identified as a UE Systems ultrasonic sensor and preamplifier Model 586, though any conventional sound detector may be used. In the embodiment shown in FIGS. 6 and 7, a lip 34 extends radially inwardly from an upper edge of the housing 21′. It is understood that the lip 34 may circumscribe the entire upper edge of the housing 21′ or the lip 34 may be an array of lips, as desired. Alternatively, the housing 21′ may not include the lip 34.

In use, the sound detector assembly is used with the blow molding apparatus of FIG. 1. The preforms are carried in the molds 14 having an inner cavity in the desired configuration or shape of the finished container to be formed. The preforms are heated to a predetermined temperature, which prepares the plastic material to be readily blow molded. Upon reaching the desired temperature, high pressure fluid, such as compressed air, is sequentially introduced into the hollow interior of the preforms. The preforms are thereby caused to expand and assume the shape of the associated mold 14. The pressure fluid is introduced into the hollow interior of the heated preform causing the preform to expand and assume the shape of the interior cavity of the mold 14 as a completed container.

As the pressure fluid is introduced into the molds 14, the platform 12 and the molds 14 are caused to rotate in a direction indicated by arrow 16 and pass the sound detector assembly disposed adjacent the periphery of the rotating platform 12. The sound detector assembly is disposed with the opening 32′ thereof facing the platform 12. In the event a hole is caused to be formed in the wall of the container, the pressure fluid enters an open upper end or finish of the container and escapes through the hole creating an acoustic signal or defect sound energy. Sound energy is directed toward the opening 32′ of the reflector 20′. Because the sound detector is disposed at the focus F′ of the parabola formed by the housing 21′, sound energy caused to travel parallel to the directrix D′ is reflected off the interior of the reflector 20′ towards the sound detector. Sound energy not parallel to the directrix D′ tend to reflect off the interior of reflector 20′ and out of the sound detector assembly and are undetected by the sound detector. This has been found to reduce the detection of background noise from adjacent molds 14 and sources other than a desired source, namely, the air caused to flow through defects in the container. Sound energy not entering the opening 32′ of the reflector 20′ are reflected off an exterior of the housing 21′ or are projected past the housing 21′ and are not detected by the sound detector. This has also been found to reduce the effects of background noise from undesired sources. Similarly, sound energy may be reflected off the lip 34 of the housing 21″ and reflected away from the sound detector. This has also been found to reduce the effects of background noise from undesired sources.

The sound detector generates an electric signal in response to detection of sound energy. The electric signal may then be sent to an amplifier (not shown) and then to a logic circuit (not shown). The logic circuit is operative to coordinate and keep track of the subsequent path of the container having the defect and will send an appropriately timed control signal to an air blow-off station to remove the container from the production line prior to filling or storage. The station may contain solenoid-operated valves controlling the flow of pressurized air capable of completing the rejection operation. The pressurized air will then be appropriate to remove the container with the defect from the production line. The completed plastic containers are then transferred from the annular rotating platform 12 to a conveyor which transports the containers to a filling station. Finally, the filled containers are suitably removed from the conveyor to be stored for later delivery or are immediately loaded on appropriate vehicles for delivery to an end-user of the container. Unfilled containers may also be off-loaded in a similar fashion.

FIG. 8 shows a reflector 20″ according to another embodiment of the invention similar to the reflector 20 of FIGS. 1-5 except as described below. Like the structure from FIGS. 1-5, FIG. 8 includes identical reference numerals accompanied by a double prime (″) symbol.

A sound detector assembly includes a substantially hollow acoustic reflector 20″ and a sound detector (not shown). As shown in FIG. 8, the acoustic reflector 20″ includes a housing 21″ having a substantially circular opening 32″. The housing 21″ of the reflector 20″ has a substantially elliptical cross-sectional shape. It is understood that the housing 21″ may have any conic cross-sectional shape such as parabolic, hyperbolic, and circular, for example, as desired. In the embodiment shown, a support 22″ is provided to extend between the walls forming the housing 21″. A portion of the support 22″ is disposed within the housing 21″ of the reflector 20″, while another portion of the support 22″ extends out of the opening 32″ of the housing 21″. The sound detector is frictionally fit within an aperture 30″ disposed centrally of the support 22″. However, an internally threaded aperture 30″ may be disposed centrally of the support 22″ to receive the sound detector, as desired. The aperture 30″ is formed in the support 22″ at a focus, and along the directrix D″ of the ellipse formed by the housing 21″. The sound detector has an input facing the hollow interior of the reflector 20″. The sound detector suitable for the purposes of the invention is commercially available from and identified as a UE Systems ultrasonic sensor and preamplifier Model 586, though any conventional sound detector may be used.

In use, the sound detector assembly is used with the blow molding apparatus 10 of FIG. 1. The preforms are carried in the molds 14 having an inner cavity in the desired configuration or shape of the finished container to be formed. The preforms are heated to a predetermined temperature, which prepares the plastic material to be readily blow molded. Upon reaching the desired temperature, high pressure fluid, such as compressed air, is sequentially introduced into the hollow interior of the preforms. The preforms are thereby caused to expand and assume the shape of the associated mold 14. The pressure fluid is introduced into the hollow interior of the heated preform causing the preform to expand and assume the shape of the interior cavity of the mold 14 as a completed container.

As the pressure fluid is introduced into the molds 14, the platform 12 and the molds 14 are caused to rotate in a direction indicated by arrow 16 and pass the sound detector assembly disposed adjacent the periphery of the rotating platform 12. The sound detector assembly is disposed with the opening 32″ thereof facing the platform 12. In the event a hole is caused to be formed in the wall of the container, the pressure fluid enters an open upper end or finish of the container and escapes through the hole creating an acoustic signal or defect sound energy. Sound energy is directed toward the opening 32″ of the reflector 20″. Because the sound detector is disposed at the focus of the ellipse formed by the housing 21″, sound energy caused to travel parallel to the directrix D″ is reflected off the interior of the reflector 20″ towards the sound detector. Sound energy not parallel to the directrix D″ tends to reflect from the interior of reflector 20″ and out of the sound detector assembly and is undetected by the sound detector. This has been found to reduce the detection of background noise from adjacent molds 14 and sources other than a desired source, namely, the air caused to flow through defects in the container. Sound energy not entering the opening 32″ of the reflector 20″ is reflected from an exterior of the housing 21″ or are projected past the housing 21″ and is not detected by the sound detector. This has also been found to reduce the effects of background noise from undesired sources.

The sound detector generates an electric signal in response to detection of sound energy. The electric signal may then be sent to an amplifier (not shown) and then to a logic circuit (not shown). The logic circuit is operative to coordinate and keep track of the subsequent path of the container having the defect and will send an appropriately timed control signal to an air blow-off station to remove the container from the production line prior to filling or storage. The station may contain solenoid-operated valves controlling the flow of pressurized air capable of completing the rejection operation. The pressurized air will then be appropriate to remove the container with the defect from the production line. The completed plastic containers are then transferred from the annular rotating platform 12 to a conveyor which transports the containers to a filling station. Finally, the filled containers are suitably removed from the conveyor to be stored for later delivery or are immediately loaded on appropriate vehicles for delivery to the ultimate customer. Unfilled containers may also be off-loaded in a similar fashion.

In accordance with the provisions of the patent statutes, the present invention has been described in what is considered to represent its preferred embodiment. However, it should be understood that the invention can be practiced otherwise than as specifically illustrated and described without departing from its spirit or scope.

I claim:

1. A method for monitoring the production of blow molded plastic containers to detect a defect in any of the containers comprising the steps of:
a. introducing pressure fluid to an interior of a preform in a mold cavity to form a blow molded plastic container;
b. providing a sound detector assembly including a reflector having a substantially conic section cross-sectional shape and a sound detector;
c. acoustically sensing a defect sound with the sound detector assembly resulting from the pressure fluid escaping from the interior of the container; and
d. generating a control signal in response to the sensed defect sound.

2. The method of claim 1, wherein the sound detector has a parabolic cross-sectional shape.

3. The method of claim 1, wherein the sound detector has a hyperbolic cross-sectional shape.

4. The method of claim 1, wherein the sound detector has an elliptical cross-sectional shape.

5. The method of claim 1, wherein the sound detector has one of a substantially rectangular opening and a substantially circular opening.

6. The method of claim 5, wherein the sound detector has a substantially rectangular opening formed from a pair of curvilinear walls joined together by a pair of rectilinear walls.

7. The method of claim 1, wherein the sound detector includes a support extending between walls thereof.

8. The method of claim 7, wherein the support forms an aperture adapted to receive the sound detector.

9. The method of claim 8, wherein the aperture is disposed at one of a focus of the reflector and along a directrix of the reflector.

10. The method of claim 9, wherein the aperture is disposed at the focus of the reflector and along the directrix of the reflector.

11. The method of claim 1, wherein the step of producing a control signal includes amplifying the control signal.

12. The method of claim 1, further including the step of rejecting the container having a hole therein.

13. The method of claim 12, wherein the step of rejecting the container includes directing pressure fluid to reject the container having a hole therein.

14. An apparatus for monitoring the production of blow molded plastic containers formed by introducing pressure fluid to an interior of a preform in a mold cavity comprising:
a sound detector assembly adapted to be positioned adjacent a mold cavity during the introduction of pressure fluid to a preform in the mold cavity to form a container, said sound detector assembly including a sound detector and a reflector having a substantially conic section cross-sectional shape and being responsive to a defect sound of the pressure fluid escaping from the interior of the container for generating an output signal; and
means for generating a control signal in response to said output signal whereby a container rejecter receiving said control signal rejects the container.

15. The apparatus of claim 14, wherein the reflector has one of a parabolic, hyperbolic, and elliptical cross-sectional shape.

16. The apparatus of claim 15, wherein the reflector has a substantially rectangular opening formed from a pair of curvilinear walls joined together by a pair of rectilinear walls.

17. The apparatus of claim 14, wherein the reflector includes a support extending between walls thereof, the support forming an aperture adapted to receive the sound detector.

18. The apparatus of claim 17, wherein the aperture is disposed at the focus of the reflector and along the directrix of the reflector.

19. An apparatus for monitoring the production of blow molded plastic containers formed by introducing pressure fluid to an interior of a preform in a mold cavity comprising:
a sound detector assembly adapted to be positioned adjacent a mold cavity during the introduction of pressure fluid to a preform in the mold cavity to form a container, said sound detector assembly including a sound detector responsive to a defect sound of the pressure fluid escaping from the interior of the container for generating an output signal and a reflector having a substantially conic section cross-sectional shape and a support extending between walls thereof, the support forming an aperture adapted to receive the sound detector; and
means for generating a control signal in response to said output signal whereby a container rejecter receiving said control signal rejects the container.

20. The apparatus of claim 19, wherein the aperture of the support is disposed at the focus of the reflector and along the directrix of the reflector.
